(19) United States
(12) Patent Application Publication
(10) Pub. No.: US 2026/0160403 A1
(43) Pub. Date: Jun. 11, 2026

(54) Lamp

(71) Applicants: ETI SOLID STATE LIGHTING INC, Wheeling, IL (US); CRAWFORD GLOBAL LIMITED, Hong Kong (CN)

(72) Inventors: Donglei WANG, Zhuhai, Guangdong (CN); Guiwu BI, Zhuhai, Guangdong (CN); Guoqiang DENG, Zhuhai, Guangdong (CN)

(21) Appl. No.: 18/276,893

(22) PCT Filed: Jul. 25, 2023
(86) PCT No.: PCT/CN2023/109182

§ 371 Date: Aug. 11, 2023

(51) Int. Cl. F21V 7/00; F21V 21/008

(52) U.S. Cl. CPC F21V 7/005; F21V 21/008

(57) ABSTRACT

The disclosure provides a lamp. The lamp includes a lamp body and a light source, where the lamp body includes two reflecting plates arranged oppositely, a light reflecting channel is defined between the two reflecting plates, the light reflecting channel is provided with a top light output port and a bottom light output port, and at least one reflecting plate of the two reflecting plates is arranged movably; and the light source is arranged in the light reflecting channel, the reflecting plates are configured to guide light irradiating the reflecting plates to the top light output port and the bottom light output port, and the reflecting plate arranged movably may increase or decrease a luminous flux of the top light output port and the bottom light output port. The lamp provided in the disclosure may solve the problems that a light output direction of the lamp is single.

### TECHNICAL FIELD

The disclosure relates to the technical field related to lighting apparatuses, and particularly relates to a lamp.

### BACKGROUND

The advent of lamps is to satisfy the needs of daily lighting in life and work. Currently, lamps on the market are generally divided into three types according to the light-emitting directions: direct ones, indirect ones, and direct+indirect ones, which correspond to three different structures of lamps.

Any type of the lamps mentioned above emits light unidirectionally. The lamps mentioned above generally have a housing wall separated from an internal reflective structure, and the housing wall is non-rotatable and unchangeable in shape, which is the same as that of lamps in the prior art. Accordingly, a lamp body and an optical system may only be combined in a single way and may not be adjusted according to requirements of an application scene of a user, causing poor user experience.

As may be seen from the above, a light output direction of the current lamps is single and may not be adjusted according to requirements of an application scene of a user.

### SUMMARY

A main objective of the disclosure is to provide a lamp to solve the problems that a light output direction of a lamp in the prior art is single and may not be adjusted according to requirements of an application scene of a user.

In order to achieve the above objective, according to an embodiment of the disclosure, a lamp is provided. The lamp includes: a lamp body, where the lamp body includes two reflecting plates arranged oppositely, a light reflecting channel is defined between the two reflecting plates, the light reflecting channel is provided with a top light output port and a bottom light output port, and at least one reflecting plate of the two reflecting plates is arranged movably; and a light source, where the light source is arranged in the light reflecting channel, the reflecting plates are configured to guide light irradiating the reflecting plates to the top light output port and the bottom light output port, and the reflecting plate arranged movably may increase or decrease a luminous flux of the top light output port and the bottom light output port.

In an embodiment mode, a light output direction of the light source and an opening direction of the bottom light output port are arranged to define an included angle, such that the light source does not directly irradiate the bottom light output port.

In an embodiment mode, surfaces of the two reflecting plates facing each other are reflecting surfaces, and the reflecting surfaces are configured to reflect light in the light reflecting channel, so as to guide the light to the top light output port and/or the bottom light output port.

In an embodiment mode, the light source is arranged in an area between the two reflecting plates; or the light source is mounted on one of the reflecting plates, and the light source emits light towards the other reflecting plate of the reflecting plates; or, the light source is mounted on each reflecting plate of the reflecting plates, and the light source on each reflecting plate emits light towards the reflecting plate on the opposite side.

In an embodiment mode, at least part of the light source is supported on the reflecting plates and defines heat dissipation gaps with the reflecting plates.

In an embodiment mode, surfaces of the two reflecting plates facing each other are reflecting surfaces, the light source is mounted on the reflecting surfaces, and the light source is directly connected to the reflecting surfaces; and/or, the reflecting surfaces are provided with mounting grooves in communication with the light reflecting channel, and at least part of the light source is mounted in the mounting grooves and emits light towards the light reflecting channel.

In an embodiment mode, surfaces of the two reflecting plates facing each other are reflecting surfaces, the reflecting surfaces are provided with mounting grooves in communication with the light reflecting channel, and a groove opening direction of the mounting grooves is the same as a perpendicular direction of the reflecting surfaces; or, an angle is defined between a groove opening direction of the mounting grooves and a perpendicular direction of the reflecting surfaces.

In an embodiment mode, the lamp further includes a polarizing lens, where the polarizing lens covers the light source, and at least part of light of the light source passes through the polarizing lens and then is emitted towards the light reflecting channel.

In an embodiment mode, surfaces of the two reflecting plates facing each other are reflecting surfaces, the reflecting surface is provided with a first groove wall slope and a second groove wall slope that are arranged to define an angle therebetween, a joint of the first groove wall slope and the second groove wall slope is provided with a positioning groove that is opened in an extension direction of the first groove wall slope or the second groove wall slope, at least part of the light source is accommodated in the positioning groove, and at least the other part of the light source is arranged on the first groove wall slope or the second groove wall slope.

In an embodiment mode, surfaces of the two reflecting plates facing each other are reflecting surfaces, the reflecting surfaces include a plurality of sub-planes, and the plurality of sub-planes are coplanar; or, at least two of the plurality of sub-planes are arranged to define an angle therebetween.

In an embodiment mode, a reflecting surface of the reflecting plate at least has a flat surface, a first groove wall slope, a second groove wall slope and a second slope that are connected in sequence in a direction of the top light output port and the bottom light output port, the light source is mounted on the first groove wall slope and/or the second groove wall slope, and the light source emits light towards the light reflecting channel.

In an embodiment mode, the lamp further includes: end plates, where the end plates are arranged on two sides of the reflecting plates in pairs, the end plates and the reflecting plates define the light reflecting channel, the top light output port and the bottom light output port, and the reflecting plate are rotatably and/or removably connected to the end plates; and mounting members, where the mounting members are connected to the end plates and/or the reflecting plates, and the mounting members are configured to be mounted at mounting positions.

In an embodiment mode, when the reflecting plates are rotatably connected to the end plates, the lamp further includes rotating mechanisms, and the reflecting plates are rotatably connected to the end plates by means of the rotating mechanisms.

In an embodiment mode, the rotating mechanisms are located on one sides of the end plates facing the light reflecting channel; or, the rotating mechanisms are located on different sides of the end plates and include mounting protrusions, one ends of the mounting protrusions are fixedly connected to the reflecting plates, and the other ends of the mounting protrusions penetrate the end plates.

In an embodiment mode, the end plate is provided with arc-shaped grooves arranged in a pair, and axial ends of the mounting protrusions of the rotating mechanisms pass through the arc-shaped grooves.

In an embodiment mode, the top light output port and the bottom light output port are located at two ends of the reflecting plates in the direction of the top light output port and the bottom light output port, and mounting protrusions of the rotating mechanisms are located in middle areas of the reflecting plates in the direction of the top light output port and the bottom light output port.

In an embodiment mode, the rotating mechanisms further include rotating portions, one ends of the rotating portions are rotatably connected to the end plates, and the two rotating portions located on the same side of the end plate are drivingly connected to link the two reflecting plates.

In an embodiment mode, the other ends of the rotating portions are connected to the reflecting plates; or the rotating mechanisms further include mounting protrusions, one ends of the mounting protrusions are connected to the reflecting plates, the other ends of the mounting protrusions penetrate the end plates so as to be connected to the other ends of the rotating portions located on outer sides of the end plates, and the rotating portions and the mounting protrusions are connected to define an angle therebetween; or, the rotating portions include extension arms and rotating heads arranged at one ends of the extension arms, and the rotating heads of the two rotating portions drivingly connected are rotatably connected.

In an embodiment mode, the lamp further includes fixing structures, where the fixing structures are arranged on the end plates, one ends of the rotating mechanisms are rotatably connected to the fixing structures, and the fixing structures are located in middle areas of the end plates; or, the top light output port and the bottom light output port are located at two ends of the reflecting plates in the direction of the top light output port and the bottom light output port, and mounting protrusions of the rotating mechanisms are located in middle areas of the reflecting plates in the direction of the top light output port and the bottom light output port.

In an embodiment mode, the fixing structures are fixing shafts, the fixing shafts are located on inner side surfaces of the end plates facing the light reflecting channel and extend in a direction facing the light reflecting channel, and at least parts of the rotating mechanisms rotatably sleeve the fixing shafts; or the fixing structures are fixing shafts, the fixing shafts are located on outer side surfaces of the end plates away from the light reflecting channel and extend in a direction away from the light reflecting channel, and at least parts of the rotating mechanisms rotatably sleeve the fixing shafts; or, the fixing structures are hole structures arranged on the end plates, and at least parts of the rotating mechanisms extend into the hole structures and are rotatably connected to the hole structure.

In an embodiment mode, the fixing structures are fixing shafts, and two rotating mechanisms arranged in a pair sleeve one fixing shaft, where a connecting end of one of the rotating mechanisms connected to the fixing shaft is provided with a groove structure, a connecting end of the other rotating mechanism connected to the fixing shaft is provided with a convex ring structure, the convex ring structure is concentric with the groove structure, at least part of the convex ring structure is accommodated in the groove structure, and the groove structure is drivingly connected to the convex ring structure by means of a rotating structure.

In an embodiment mode, the rotating structures are pawl structures, and the pawl structure includes ratchet grooves circumferentially arranged along an inner wall surface of the groove structure, and ratchet teeth arranged on an outer circumferential surface of the convex ring structure; or, the pawl structure includes ratchet teeth circumferentially arranged along an inner wall surface of the groove structure, and ratchet grooves arranged on an outer circumferential surface of the convex ring structure.

In an embodiment mode, the fixing structures are fixing shafts, two rotating mechanisms arranged in a pair sleeve two fixing shafts respectively, and one ends of the two rotating mechanisms connected to the fixing shafts are connecting ends, and the two connecting ends mesh; and/or, the lamp further includes a drive member, one ends of the two rotating mechanisms connected to the fixing shafts are connecting ends, and the drive member is drivingly connected to the connecting ends.

In an embodiment mode, the lamp further includes: a rotating shaft, where at least one of the two reflecting plates oppositely arranged is rotatably connected to the rotating shaft; and a mounting member, where the mounting member is rotatably connected to the rotating shaft, and the mounting member is configured to be mounted at a mounting position.

In an embodiment mode, the lamp further includes connecting arms, where each reflecting plate is rotatably connected to the rotating shaft by means of the connecting arm, one ends of the connecting arms are fixedly connected to the reflecting plates, and the other ends of the connecting arms rotatably sleeve the rotating shaft.

In an embodiment mode, the lamp further includes: a connecting arm, where one end of the connecting arm is fixedly connected to one of the reflecting plates, and the other end of the connecting arm rotatably sleeves the rotating shaft; and a fixing arm, where one end of the fixing arm is fixedly connected to one of the reflecting plates, and the other end of the fixing arm is fixedly connected to the rotating shaft.

In an embodiment mode, the lamp includes: a link rod assembly, where the two reflecting plates arranged in a pair are linked and cooperate by means of the link rod assembly; a mounting member, where the mounting member is connected to the reflecting plates, and the mounting member is configured to be mounted at a mounting position; and positioning connectors, where the reflecting plates are connected to the mounting member by means of the positioning connectors.

In an embodiment mode, the positioning connectors are flexible connectors, the mounting member is provided with a hanging ring, one end of the positioning connector is connected to one of the two reflecting plates arranged in a pair, and the other end of the positioning connector penetrates the hanging ring and then is connected to one of the two reflecting plates; or, the positioning connectors are connecting rods, one ends of the positioning connectors are connected to the reflecting plates, and the other ends of the positioning connectors are connected to the mounting member.

In an embodiment mode, the link rod assembly includes two link rods symmetrically arranged to define an angle therebetween, two ends of each link rod are connected to the two reflecting plates respectively, a distance between a first end of each link rod and the top light output port is less than a distance between a second end of each link rod and the top light output port, and the two link rods form an X-shaped structure.

In an embodiment mode, when the reflecting plates are removably connected to the end plates, the end plates are provided with slide grooves, the reflecting plates are provided with protruding structures at least partially extending into the slide grooves, the protruding structures are removable in the slide grooves, and the slide grooves extend in a direction in which the two reflecting plates face each other, such that the two reflecting plates move close to or away from each other; and/or, the slide grooves extend in a direction of the top light output port and the bottom light output port, such that the two reflecting plates are flush or misaligned in the direction of the top light output port and the bottom light output port; and/or, the slide grooves extend in a direction defining an angle with a direction in which the two reflecting plates face each other, such that the two reflecting plates are aligned or misaligned.

In an embodiment mode, the lamp further includes light leakage preventing members, where the light leakage preventing members are arranged between the reflecting plates and the end plates, and the light leakage preventing members are made from one or a combination of at least two of felt, original cork, environment-friendly recycled plastic fabric, recycled wood, bamboo and wood fiber boards.

In an embodiment mode, the lamp further includes a light blocking bar, where the light blocking bar is arranged in the light reflecting channel, a light output end of the light source is arranged towards the light blocking bar, at least a surface of the light blocking bar facing the light source is a reflecting surface, and the light blocking bar is located between the light source and the top light output port in the direction of the top light output port and the bottom light output port; or, the light blocking bar is located between the light source and the bottom light output port in the direction of the top light output port and the bottom light output port.

In an embodiment mode, the light blocking bar is movably arranged in the light reflecting channel.

In an embodiment mode, the reflecting plates are arranged in pairs, and surfaces of the two reflecting plates arranged in a pair, which are away from each other, are planes or curved surfaces; and/or, the reflecting plates are made from a translucent material or a transparent material; and/or, surfaces of the two reflecting plates arranged in a pair, which are close to each other, are covered with light reflecting films, light reflecting paint, or light reflecting powder.

In an embodiment mode, the light source is movably arranged in the light reflecting channel; and/or, the light source is a linear light source; and/or, the light source is mounted on the end plates of the lamp; and/or, the light blocking bar of the lamp is arranged on the end plates of the lamp; and/or, the lamp is a strip lamp.

According to the technical solution in the disclosure, the lamp includes a lamp body and a light source, where the lamp body includes two reflecting plates arranged oppositely, a light reflecting channel is defined between the two reflecting plates, the light reflecting channel is provided with a top light output port and a bottom light output port, at least one reflecting plate of the two reflecting plates is arranged movably, the light source is arranged in the light reflecting channel, the reflecting plates are configured to guide light irradiating the reflecting plates to the top light output port and the bottom light output port, and the reflecting plate arranged movably may increase or decrease a luminous flux of the top light output port and the bottom light output port.

It may be seen from the above that the lamp in the disclosure uses a structure of double light output ports of a top light output port and a bottom light output port. Moreover, the disclosure has the reflecting plate arranged movably, such that movable adjustment is performed by means of the reflecting plate, then light is reflected towards the top light output port or the bottom light output port, and a function of guiding light is achieved. The luminous flux of the top light output port and the bottom light output port is adjusted by adjusting the reflecting plates, such that the output light is adjusted according to requirements of a use scene, and the user experience is improved.

### BRIEF DESCRIPTION OF THE DRAWINGS

The accompanying drawings of the specification forming a part of the disclosure serve to provide a further understanding of the disclosure, and the illustrative embodiments of the disclosure and the description of the illustrative embodiments serve to explain the disclosure and are not to be construed as unduly limiting the disclosure. In the drawings:

FIG. 1 is a schematic diagram of a three-dimensional structural of a lamp according to Embodiment 1 in the disclosure;

FIG. 2 is a schematic diagram of a light source mounting structure of the lamp according to Embodiment 1 in the disclosure, where a light source is mounted on a second groove wall slope;

FIG. 3 is a schematic diagram of a three-dimensional structure of a reflecting surface of the lamp according to Embodiment 1 in the disclosure;

FIG. 4 is a diagram of a three-dimensional structure of the lamp according to Embodiment 1 in the disclosure, where two rotating portions arranged in a pair sleeve two fixing shafts respectively; FIG. 5 is a schematic diagram of a lamp in the disclosure in which a top light output port has a same size as a bottom light output port and a light blocking bar is in a first state;

FIG. 6 is a schematic diagram of a lamp in the disclosure in which a top light output port has a same size as a bottom light output port and a light blocking bar is in a second state;

FIG. 7 is a schematic diagram of a lamp in the disclosure in which a top light output port is larger than a bottom light output port and a light blocking bar is in a first state;

FIG. 8 is a schematic diagram of a lamp in the disclosure in which a top light output port is larger than a bottom light output port and a light blocking bar is in a second state;

FIG. 9 is a schematic diagram of a lamp in the disclosure in which a top light output port is smaller than a bottom light output port and a light blocking bar is in a first state;

FIG. 10 is a schematic diagram of a lamp in the disclosure in which a top light output port is smaller than a bottom light output port and a light blocking bar is in a second state;

FIG. 11 is a schematic diagram of a lamp in the disclosure in which a top light output port has a same size as a bottom light output port and a light blocking bar is in a fourth state;

FIG. 12 is a schematic diagram of a lamp in the disclosure in which a top light output port has a same size as a bottom light output port and a light blocking bar is in a third state;

FIG. 13 is a schematic diagram of a lamp in the disclosure in which a top light output port is larger than a bottom light output port and a light blocking bar is in a fourth state;

FIG. 14 is a schematic diagram of a lamp in the disclosure in which a top light output port is larger than a bottom light output port and a light blocking bar is in a third state;

FIG. 15 is a schematic diagram of a lamp in the disclosure in which a top light output port is smaller than a bottom light output port and a light blocking bar is in a fourth state;

FIG. 16 is a schematic diagram of a lamp in the disclosure in which a top light output port is smaller than a bottom light output port and a light blocking bar is in a third state;

FIG. 17 is a schematic diagram of a mounting structure of two rotating portions arranged in a pair and an end plate according to Embodiment 1 in the disclosure;

FIG. 18 is a schematic diagram of a drive structure of two rotating portions arranged in a pair and a drive member according to Embodiment 1 in the disclosure;

FIG. 19 is a schematic structural diagram in which surfaces of reflecting plates away from each other are planes according to Embodiment 1 in the disclosure;

FIG. 20 is a schematic structural diagram of a light leakage preventing member arranged between a reflecting plate and an end plate according to Embodiment 1 in the disclosure;

FIG. 21 is another schematic structural diagram of the light leakage preventing member arranged between the reflecting plate and the end plate according to Embodiment 1 in the disclosure;

FIG. 22 is a schematic structural diagram showing that a light source is arranged on a reflecting surface according to Embodiment 2 in the disclosure;

FIG. 23 is a schematic diagram of a three-dimensional structure showing that a light source is arranged on a reflecting surface according to Embodiment 2 in the disclosure;

FIG. 24 is a schematic structural diagram Embodiment a light source is arranged in a mounting groove on a reflecting surface according to Embodiment 3 in the disclosure;

FIG. 25 is a diagram of a three-dimensional structure of a lamp according to Embodiment 4 in the disclosure;

FIG. 26 is a schematic diagram of a mounting structure of two rotating portions arranged in a pair in FIG. 25;

FIG. 27 is a schematic structural diagram in which surfaces of reflecting plates away from each other are curved surfaces according to Embodiment 5 in the disclosure;

FIG. 28 is a diagram of a three-dimensional structure of a lamp according to Embodiment 6 in the disclosure;

FIG. 29 is a schematic structural diagram of heat dissipation gaps between reflecting plates and light sources according to Embodiment 8 in the disclosure; and FIG. 30 is a schematic structural diagram in which distances between a light source and two reflecting plates are equal according to Embodiment 8 in the disclosure.

The above-mentioned figures include the following reference numerals:

10, lamp body; 101, top light output port; 102, bottom light output port; 103, light reflecting channel; 1031, heat dissipation gap; 104, mounting groove; 110, reflecting plate; 111, first slope; 112, flat surface; 113, first groove wall slope; 114, second groove wall slope; 115, second slope; 120, end plate; 121, fixing shaft; 20, light source; 210, polarizing lens; 30, light blocking bar; 301, first arc-shaped section; 302, second arc-shaped section; 303, third arc-shaped section; 40, mounting protrusion; 410, rotating portion; 411, extension arm; 412, groove structure; 413, rotating structure; 414, convex ring structure; 50, mounting member; 60, link rod assembly, 70, positioning connector; 80, light leakage preventing member; and 90, drive member.

### DETAILED DESCRIPTION OF THE EMBODIMENTS

It should be noted that the embodiments in the disclosure and features in the embodiments may be combined without conflicts. The disclosure will be described below with reference to the drawings and in combination with the embodiments in detail.

It is to be noted that unless otherwise defined, all technical and scientific terms used in the disclosure have the same meanings usually understood by the general technical personnel in the technical field of the disclosure.

In the disclosure, directional terms such as “upper”, “lower”, “top”, and “bottom” are used generally with respect to directions shown in the drawings, or with respect to vertical, perpendicular, or gravitational directions of components unless otherwise specified. Similarly, for ease of understanding and description, “inner” and “outer” refer to inner and outer relative to contours of the components, but the above directional terms are not intended to limit the disclosure.

In order to solve the problems that a light output direction of the lamp in the prior art is single and may not be adjusted according to requirements of an application scene of a user, the disclosure provides a lamp. The lamp may be used in the household field or the industrial field.

### Embodiment 1

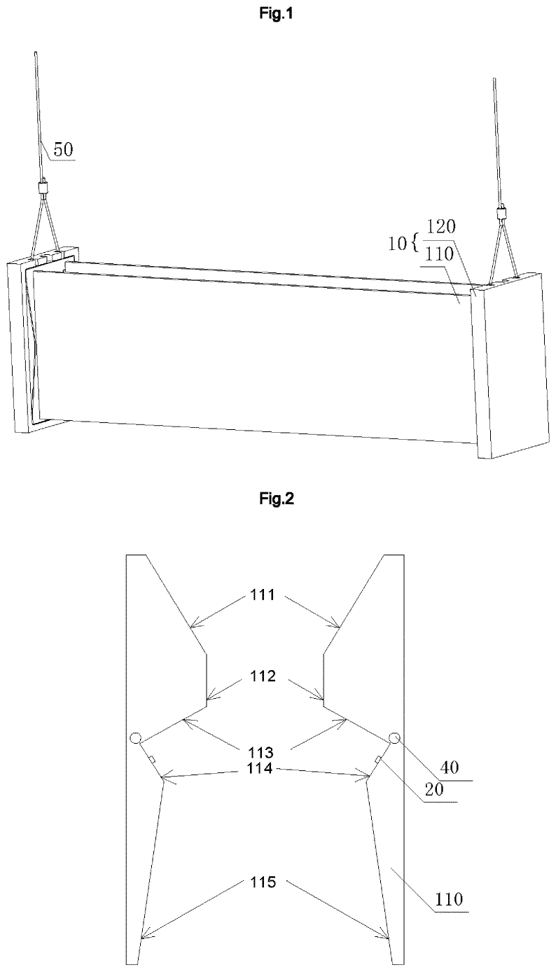

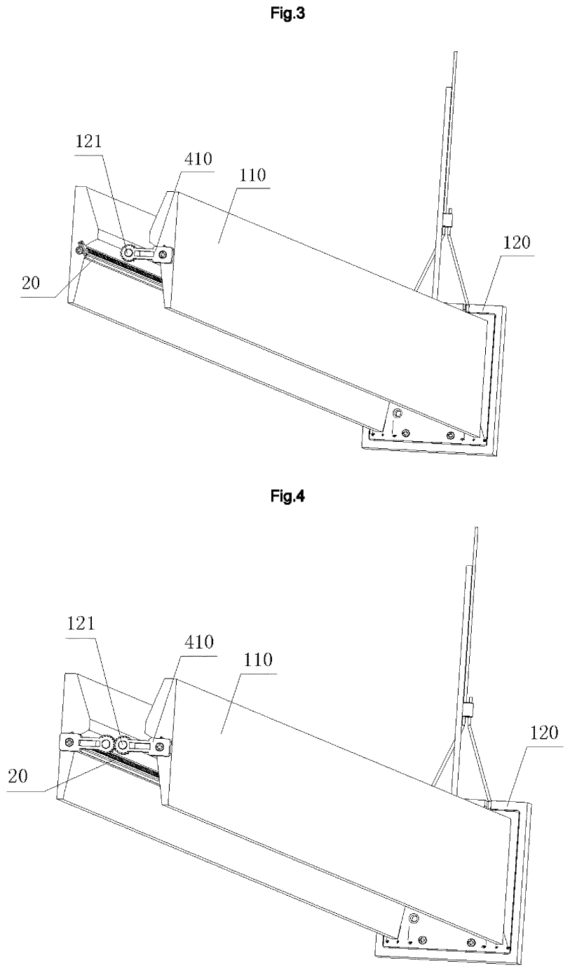

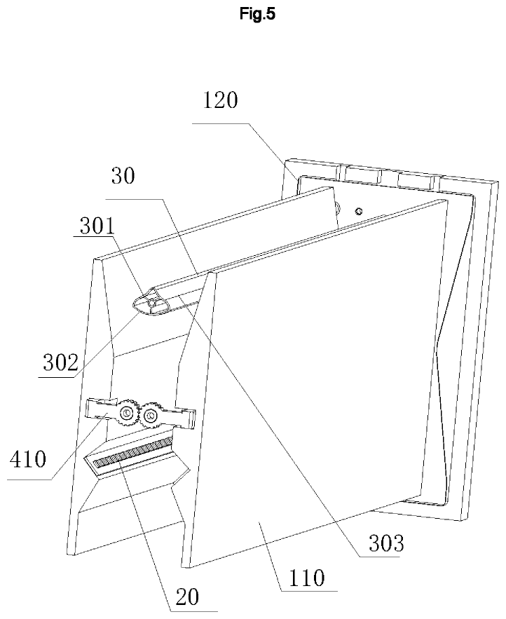

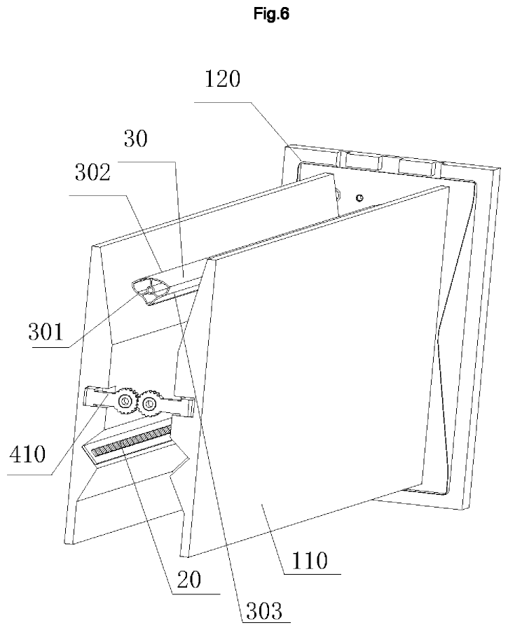

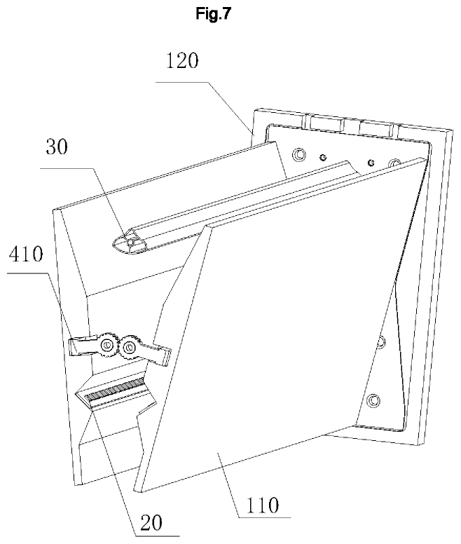

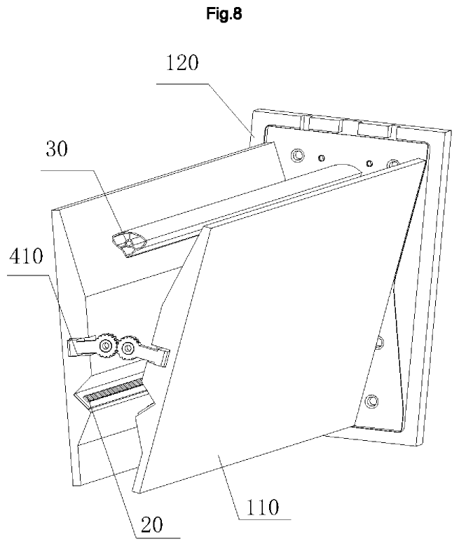

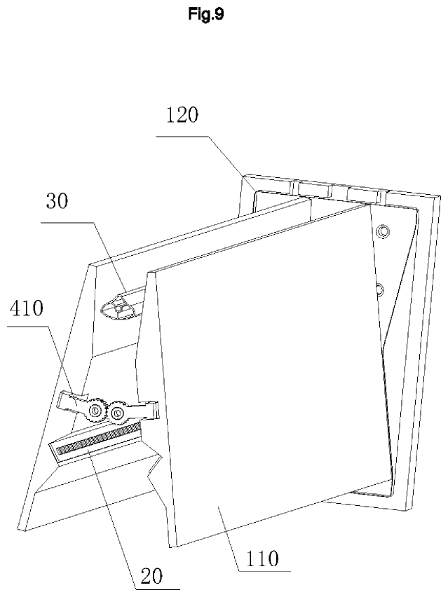

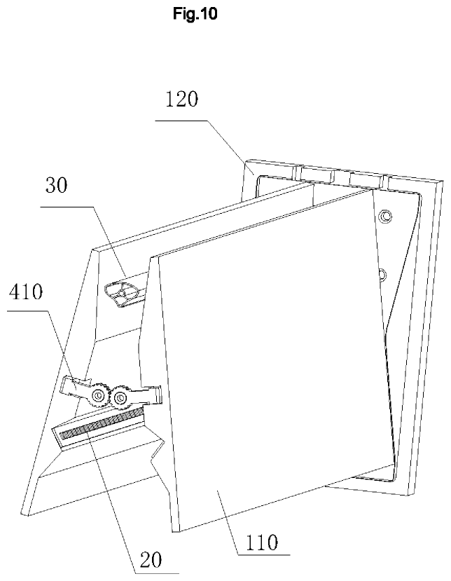

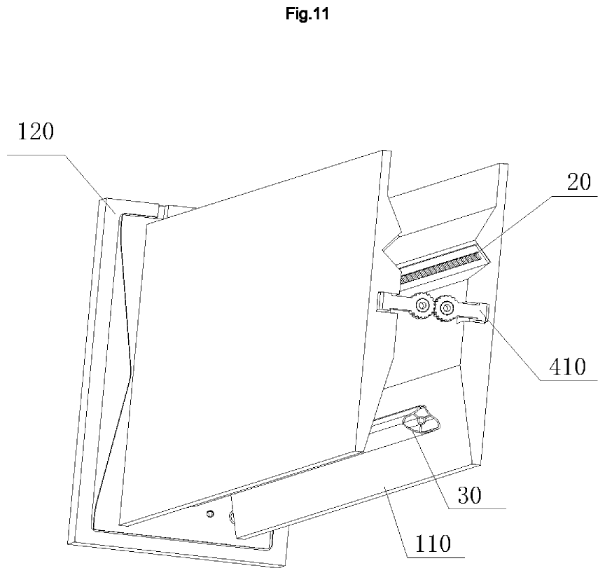

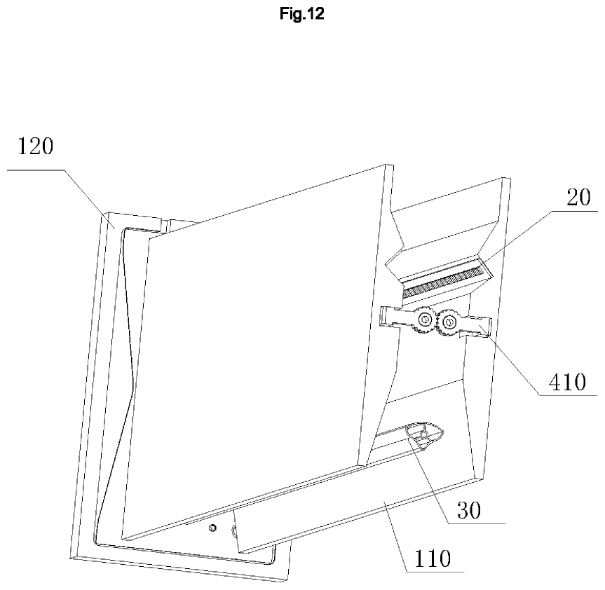

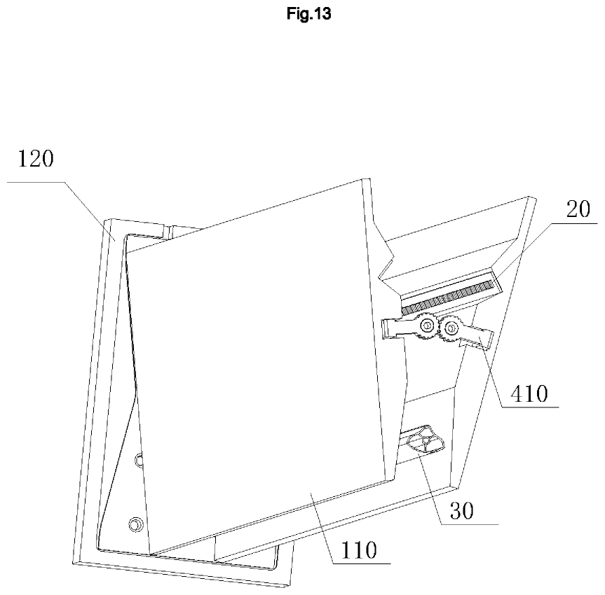

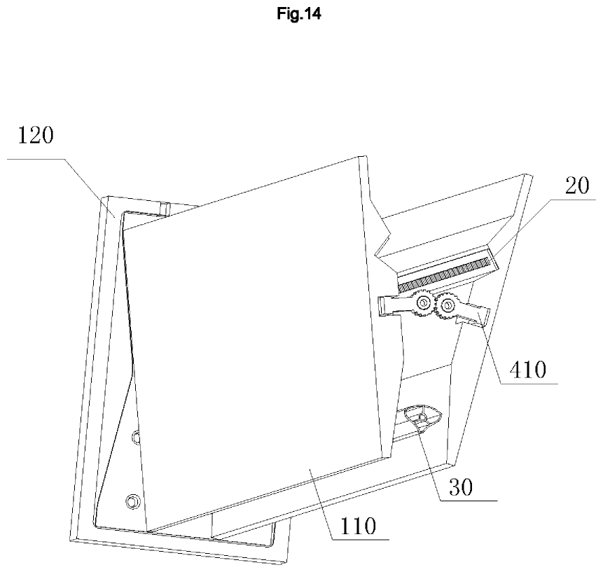

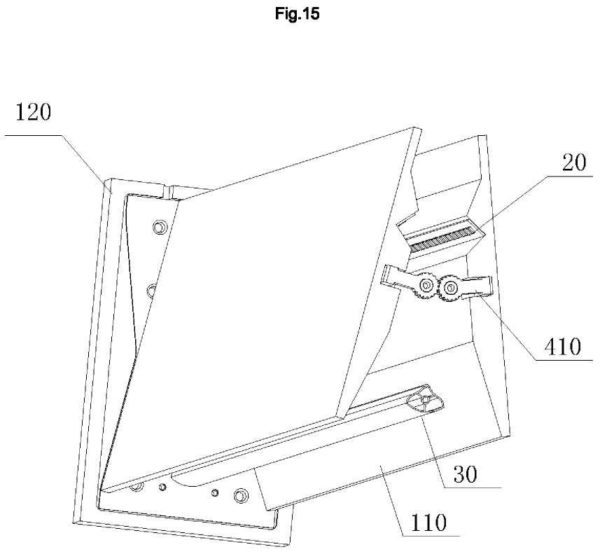

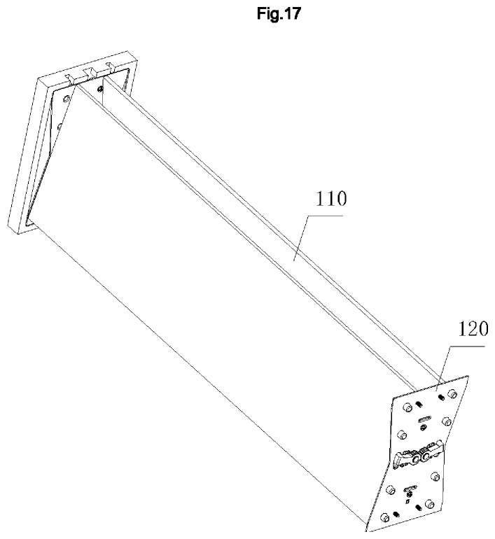

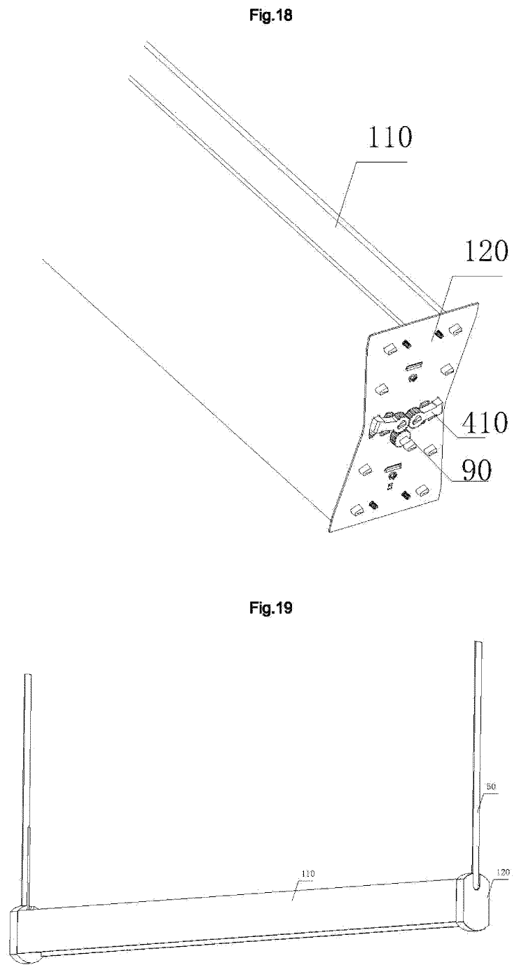

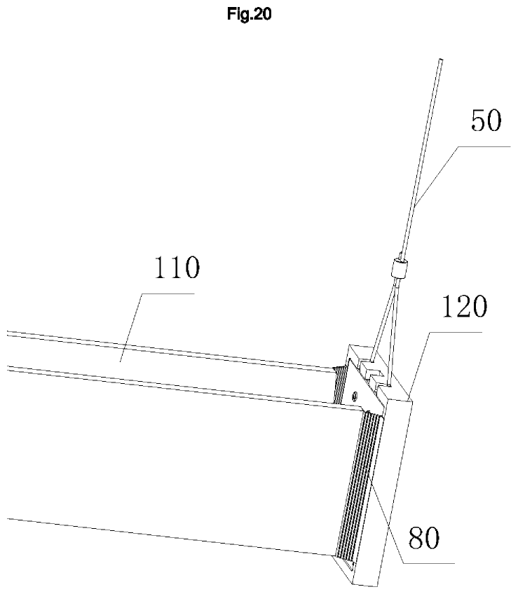

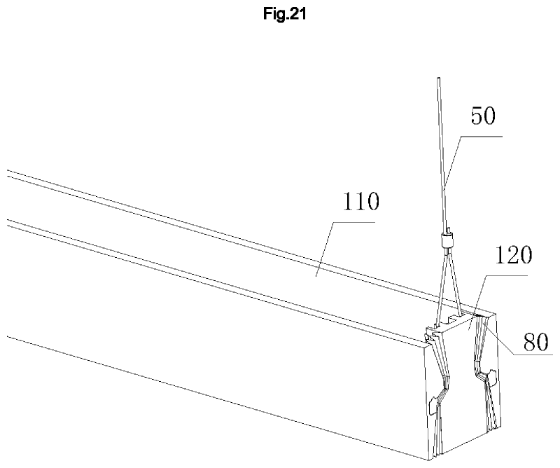

As shown in FIGS. 1-21, the lamp includes a lamp body 10 and a light source 20. The lamp body 10 includes two reflecting plates 110 arranged oppositely, a light reflecting channel 103 is defined between the two reflecting plates 110, the light reflecting channel 103 is provided with a top light output port 101 and a bottom light output port 102, and at least one reflecting plate 110 of the two reflecting plates 110 is arranged movably. The light source 20 is arranged in the light reflecting channel 103, the reflecting plates 110 are configured to guide light irradiating the reflecting plates 110 to the top light output port 101 and the bottom light output port 102, and the reflecting plate 110 arranged movably may increase or decrease a luminous flux of the top light output port 101 and the bottom light output port 102.

The top light output port 101 and the bottom light output port 102 are located at two ends of the reflecting plates 110 in a height direction for light output.

Specifically, the lamp in the disclosure uses a structure of double light output ports of a top light output port 101 and a bottom light output port 102. Moreover, the disclosure has the reflecting plate 110 arranged movably, such that movable adjustment is performed by means of the reflecting plate 110, then light is reflected towards the top light output port 101 or the bottom light output port 102, and a function of guiding light is achieved. The luminous flux of the top light output port 101 and the bottom light output port 102 is adjusted by adjusting the reflecting plates 110, such that the output light is adjusted according to requirements of a use scene, and the user experience is improved.

In an embodiment mode, surfaces of the two reflecting plates 110 facing each other are reflecting surfaces, and the reflecting surfaces are configured to reflect light in the light reflecting channel 103, so as to guide the light to the top light output port 101 and/or the bottom light output port 102. The light is reflected by the reflecting surfaces of the reflecting plates 110, such that the light of the light source 20 is emitted from the top light output port 101 and the bottom light output port 102 after being reflected for one or more times. The reflecting plates 110 are rotated to adjust a reflecting angle, such that the luminous flux of the top light output port 101 and the bottom light output port 102 is adjusted.

In the present embodiment, at least one reflecting plate 110 of the two reflecting plates 110 is arranged rotatably, such that the opening of the bottom light output port 102 and the opening of the top light output port 101 is adjusted to be increased or decreased by rotating the reflecting plate 110. When the opening of the top light output port 101 increases, the luminous flux of the top light output port 101 increases. Meanwhile, the opening of the bottom light output port 102 decreases, and the luminous flux of the bottom light output port 102 decreases.

It should be noted that when the reflecting plate 110 rotates, the sizes of the top light output port 101 and the bottom light output port 102 are relatively and synchronously changed, and the luminous flux of the top light output port 101 and the bottom light output port 102 is changed through the technical means of rotation, such that needs of different scenes and people are satisfied.

In an embodiment mode, one of the two reflecting plates 110 oppositely arranged may be rotatable, and the other one is fixedly arranged, such that a change of the top light output port 101 and the bottom light output port 102 between the two reflecting plates is implemented by means of rotation of a single plate. Alternatively, the two reflecting plates 110 are rotated, and the sizes of the openings of the top light output port 101 and the bottom light output port 102 are changed by rotating the two reflecting plates 110.

In the present embodiment, a light output direction of the light source 20 and an opening direction of the bottom light output port 102 are arranged to define an included angle, such that the light source 20 does not directly irradiate the bottom light output port 102. The included angle is greater than 0° and less than 360°. Specifically, the angle is adaptively adjusted according to the needs of a situation.

It should be noted that in the disclosure, “not directly irradiate” refers to that the light emitted from the light source 20 is reflected by any light reflecting member in the light reflecting channel 103 and then emitted from the top light output port 101 and the bottom light output port 102. Certainly, in practical applications, not all light is reflected, and part of the light emitted from the light source 20 is directly emitted from the top light output port 101 and the bottom light output port 102 without being reflected, that is, part of the light is directly emitted.

As shown in FIGS. 1-21, the light source 20 is mounted on the reflecting plates 110, so as to move synchronously with the reflecting plates 110, and the reflecting plates 110 are rotated to adjust the light source 20.

The light source 20 is arranged on one of the reflecting plates 110 only. The light source 20 is mounted on one of the reflecting plates 110, and the light source 20 emits light towards the other reflecting plate 110. The light of the light source 20 is emitted towards the other reflecting plate 110, and then reflected by the reflecting surface of the other reflecting plate 110, such that an effect of guiding light is achieved.

In an embodiment mode, the light source 20 is mounted on each reflecting plate 110. The light source 20 on each reflecting plate 110 emits light towards the reflecting plate 110 on the opposite side.

It should be noted that in the direction of the top light output port 101 and the bottom light output port 102, the light source 20 is arranged in a middle area of the reflecting plate 110. In the middle area, in the case that the light source 20 is arranged on one reflecting plate 110 or the two reflecting plates 110 are provided with the light sources 20, one or more light sources 20 are arranged on each reflecting plate 110. Specifically, when a plurality of light sources 20 are arranged, the plurality of light sources 20 are spaced in a height direction of the reflecting plate 110. The number of the light sources 20 on the two reflecting plates 110 may be equal or not. The light sources 20 on the two reflecting plates 110 are aligned, and at least some of the light sources 20 may also be misaligned.

In the present embodiment, the light source 20 is mounted on the reflecting plate 110. In order to improve the heat dissipation efficiency of the light source 20, part of the light source 20 is supported on the reflecting plate 110, and a heat dissipation gap 1031 is formed between the light source and the reflecting plate 110. The heat dissipation gap 1031 is formed between the light source 20 and the reflecting plate 110, to improve the heat dissipation efficiency of the light source 20, such that the service life and the use efficiency of the light source 20 is improved.

In the present embodiment, the lamp further includes a polarizing lens 210. The polarizing lens 210 covers the light source 20, and at least part of light of the light source 20 passes through the polarizing lens 210 and then is emitted towards the light reflecting channel 103. By arranging the polarizing lens 210, the light source 20 may enter the light reflecting channel 103 by means of the lens, which not only enlarges a light emitting area of light, but also has the technical effect of protecting the light source 20.

As shown in FIGS. 1-21, the reflecting surfaces are provided with mounting grooves 104 in communication with the light reflecting channel 103, and at least part of the light source 20 is mounted in the mounting grooves 104 and emits light towards the light reflecting channel 103.

Specifically, an angle is provided with a groove opening direction of the mounting grooves 104 and a perpendicular direction of the reflecting surfaces, such that the light of the light source 20 is emitted into the light reflecting channel 103 in the groove opening direction of the mounting grooves 104. The light entering the light reflecting channel 103 is emitted towards the reflecting plate 110 on the opposite side; and alternatively, part of the light entering the light reflecting channel 103 is emitted towards the reflecting plate 110 on the opposite side, and part of the light directly irradiates the top light output port 101 or the bottom light output port 102.

In an embodiment mode, each reflecting surface is provided with a first groove wall slope 113 and a second groove wall slope 114 that are arranged to define an angle therebetween, a joint of the first groove wall slope 113 and the second groove wall slope 114 is provided with a positioning groove that is opened in an extension direction of the first groove wall slope 113 or the second groove wall slope 114, at least part of the light source 20 is accommodated in the positioning groove, and at least the other part of the light source 20 is arranged on the first groove wall slope 113 or the second groove wall slope 114.

Specifically, the first groove wall slope 113 and the second groove wall slope 114 that are arranged to define an angle therebetween form a mounting area of the light source 20. The light source 20 is arranged on the first groove wall slope 113 or the second groove wall slope 114.

In an embodiment mode, the first groove wall slope 113 is perpendicular to the second groove wall slope 114.

In an embodiment mode, in order to improve mounting stability of the light source 20, a positioning groove is provided at a junction of the first groove wall slope 113 and the second groove wall slope 114, and part of the light source 20 extends into the positioning groove, such that the function of limiting mounting of the light source 20 is achieved. The light source 20 exposed outside the positioning groove is arranged on the first groove wall slope 113 or the second groove wall slope 114 for emitting light.

In the present embodiment, each reflecting surface includes a plurality of sub-planes, and at least two of the plurality of sub-planes are arranged to define an angle therebetween. The first groove wall slope 113 and the second groove wall slope 114 are the sub-planes.

Specifically, a reflecting surface of the reflecting plate 110 at least has a flat surface 112, a first groove wall slope 113, a second groove wall slope 114 and a second slope 115 which are connected in sequence in a direction of the top light output port 101 and the bottom light output port 102. The light source 20 is mounted on the first groove wall slope 113 and/or the second groove wall slope 114, and the light source 20 emits light towards the flat surface 112 on the opposite side.

In the present embodiment, the flat surface 112 is close to the top light output port 101, and a second end of the reflecting plate 110 located at the bottom light output port 102 has a second slope 115. The flat surface 112, the first groove wall slope 113, the second groove wall slope 114 and the second slope 115 are all sub-planes in the present embodiment. The flat surface 112 is configured to limit a size of the top light output port 101 or the bottom light output port 102. A slope of the first groove wall slope 113 and the second groove wall slope 114 on which the light source 20 is mounted is configured to limit a light emitting angle, and a slope of the first groove wall slope 113 and the second groove wall slope 114 on which no light source 20 is mounted are configured to limit a reflecting angle. The second slope 115 is configured to limit a light output angle of the bottom light output port 102.

In an embodiment mode, a first end of each reflecting surface located at the top light output port 101 has a first slope 111. A second end of each reflecting plate 110 located at the bottom light output port 102 has a second slope 115. The top light output port 101 and the bottom light output port 102 are in a flared structure by means of arrangement of the first slope 111 and the second slope 115. The second slope 115 is configured to limit the light output angle of the bottom light output port 102. The first slope 111 is configured to reduce weight and also has a function of limiting the light output angle of the top light output port 101.

As shown in FIGS. 1-21, the lamp further includes end plates 120 and mounting members 50. The end plates 120 are arranged on two sides of the reflecting plates 110 in pairs, the end plates 120 and the reflecting plates 110 define the light reflecting channel 103, the top light output port 101 and the bottom light output port 102, and the reflecting plates 110 are rotatably connected to the end plates 120. The mounting members 50 are connected to the end plates 120 and/or the reflecting plates 110, and the mounting members 50 are configured to be mounted at mounting positions.

Specifically, the end plates 120 provide mounting for the rotatable reflecting plates 110. The end plates 120 and the reflecting plates 110 define the light reflecting channel 103. The end plates 120 have a technical effect of blocking light, such that the light of the light source 20 is emitted from the top light output port 101 or the bottom light output port 102.

In an embodiment mode, the mounting members 50 are structural members such as connecting rods, lifting ropes, etc. The mounting positions are on a wall, a ceiling, a cabinet floor, etc.

In an embodiment mode, the lamp further includes rotating mechanisms, the reflecting plates 110 are rotatably connected to the end plates 120 by means of the rotating mechanisms, and the rotating mechanisms are located at different sides of the end plates 120.

In the present embodiment, the rotating mechanisms include rotating portions 410 and mounting protrusions 40 connected to the end plates 120. The reflecting plates 110 are fixedly connected to the mounting protrusions 40. One ends of the mounting protrusions 40 are fixedly connected to the reflecting plates 110, and the other ends of the mounting protrusions 40 penetrate the end plates 120 so as to be connected to the rotating portions 410. Two rotating portions 410 located on the same side of the end plates 120 are drivingly connected, such that the two reflecting plates 110 are linked.

In the present embodiment, the rotating portions 410 located on the same side of the two end plates 120 are drivingly connected, such that when one of the two opposite reflecting plates 110 rotates under an external force, the other reflecting plate 110 also rotates. The external force may be manually applied to adjust the position of the reflecting plate 110 by manually rotating the reflecting plate 110. Alternatively, a drive member 90 is used to drive the reflecting plate 110 to rotate. Specifically, the drive member 90 is mounted on the end plate 120, and an output shaft of the drive member 90 abuts against the reflecting plate 110, so as to provide a drive force for rotation of the reflecting plate 110 by means of telescopic movement of the output shaft.

It should be noted that the drive member 90 is an electric motor, an air cylinder or other structural member capable of providing a drive force.

As shown in FIGS. 1-21, the lamp further includes fixing structures. The fixing structures are arranged on the end plates 120, one ends of the rotating mechanisms are rotatably connected to the fixing structures, and the fixing structures are located in middle areas of the end plates.

The fixing structures are fixing shafts 121. The fixing shafts 121 are mounted on the end plates 120. The rotating portions 410 rotatably sleeve the fixing shafts 121.

Specifically, the rotating portions 410 include extension arms 411 and rotating heads arranged at ends of the extension arms 411. The extension arms 411 and the mounting protrusions 40 are arranged to define an angle therebetween. First ends of the extension arms 411 are connected to the mounting protrusions 40, and the rotating heads are arranged at second ends of the extension arms 411. The rotating heads of the two rotating portions 410 drivingly connected are rotatably connected. The rotating heads sleeve the fixing shafts 121 and are rotatably connected to the fixing shafts 121.

In an embodiment mode, in the direction in which the two reflection plates 110 face each other, distances between an arrangement area of the fixing shafts 121 and the two reflecting plates 110 are equal, that is, the fixing shafts are arranged in the middle area of the two reflecting plates 110. Moreover, the arrangement area of the fixing shafts 121 is also located in the middle area in a height direction of the reflecting plates 110.

In an embodiment mode, the end plate 120 is provided with arc-shaped grooves arranged in a pair. Axial ends of the mounting protrusions 40 pass through the arc-shaped grooves so as to be connected to the rotating portions 410. The rotating portions 410 are located outside the light reflecting channel 103.

It should be noted that the arc-shaped grooves provide avoiding positions for the rotating portions 410 to rotate, so as to avoid a phenomenon that the rotating portions 410 and the end plates 120 may not abut against each other and may not rotate.

Certainly, the structure is not limited to the arc-shaped grooves, and other structures may be realized, such as circular via holes, square via holes, etc.

In the present embodiment, the two rotating portions 410 arranged in a pair respectively sleeve the two fixing shafts 121, and the two rotating portions 410 mesh to achieve a linkage effect by meshing. When the reflecting plates 110 need to be rotated manually, only one reflecting plate 110 needs to be rotated under the effect of meshing of the two reflecting plates 110. When the drive member 90 needs to drive the reflecting plates 110 to rotate, the drive member 90 is mounted on the end plate 120, and the drive member 90 is drivingly connected to the two rotating portions 410.

As shown in FIGS. 1-21, the lamp further includes light leakage preventing members 80. The light leakage preventing members 80 are arranged between the reflecting plates 110 and the end plates 120, and the light leakage preventing members 80 are made from one or a combination of at least two of felt, original cork, environment-friendly recycled plastic fabric, recycled wood, bamboo and wood fiber boards.

Specifically, the light leakage preventing members 80 are provided to prevent light leakage from occurring in areas where the end plates 120 and the reflecting plates 110 are rotatably connected.

In an embodiment mode, the reflecting plates 110 in the present embodiment are not limited to be made from an opaque light reflecting material. The reflecting plates 110 may also be made from a translucent material or a transparent material if necessary, so as to reflect light by the reflecting plates 110 and allow part of light to pass through the reflecting plates 110 to be emitted laterally. For example, a prism structure that may achieve both reflection and refraction may be used.

In an embodiment mode, in order to improve the reflecting efficiency, the reflecting surface is covered with a light reflecting film, light reflecting paint or light reflecting powder.

In the present embodiment, the light source 20 is a linear light source 20, and the entire lamp is of a strip lamp structure.

In the present embodiment, end surfaces of the reflecting plates 110 away from each other are of a planar structure.

It should be noted that the movable connection manner described in the disclosure includes two types of rotation connection and removable connection.

### Embodiment 2

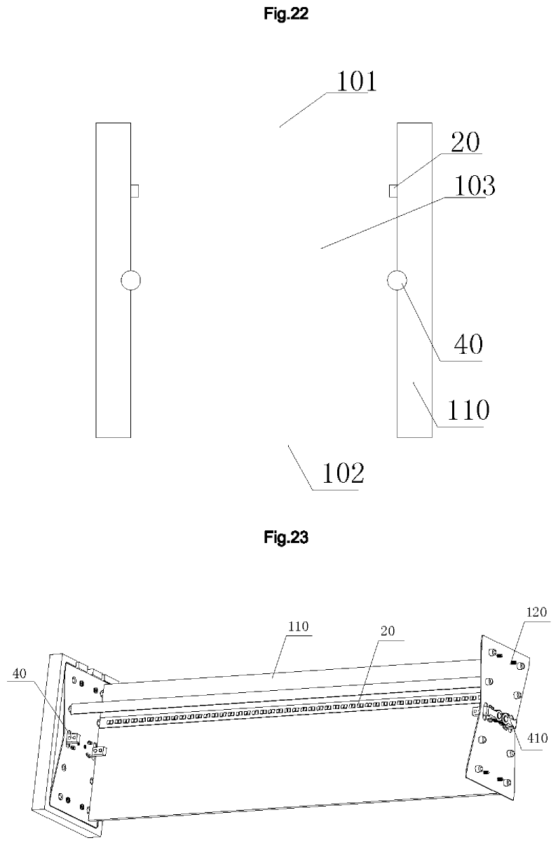

Different from Embodiment 1, in the present embodiment, as shown in FIGS. 22 and 23, the reflecting surfaces includes a plurality of sub-planes. Each reflecting surface includes a plurality of sub-planes, and the plurality of sub-planes are coplanar to define an integral planar structure. The integral planar structure is arranged in the direction of the top light output port 101 and the bottom light output port 102 of the reflecting plates 110.

Specifically, in the present embodiment, no mounting groove 104 is arranged on the reflecting surfaces, and the light source 20 is directly arranged on the reflecting surfaces, such that the effect that the light source 20 rotates along with the reflecting plates 110 is achieved.

In an embodiment mode, the light source 20 is arranged on an integral plane, and emits light towards an integral plane on the opposite side, such that the light is reflected to achieve the effect of guiding light to the top light output port 101 and the bottom light output port 102.

### Embodiment 3

Different from Embodiment 1, in the present embodiment, as shown in FIG. 24, the reflecting surfaces are provided with mounting grooves 104 in communication with the light reflecting channel 103. A groove opening direction of the mounting grooves 104 is the same as a perpendicular direction of the reflecting surfaces.

In the present embodiment, at least part of the light source 20 is mounted in the mounting grooves 104, and the polarizing lens 210 covers the light source 20, such that the light of the light source 20 is offset from the light perpendicularly emitted from the reflecting surfaces after passing through the polarizing lens 210, and then is emitted to the reflecting surfaces at an angle, so as to be guided to the top light output port 101 or the bottom light output port 102 under the reflecting effect of the reflecting surfaces.

### Embodiment 4

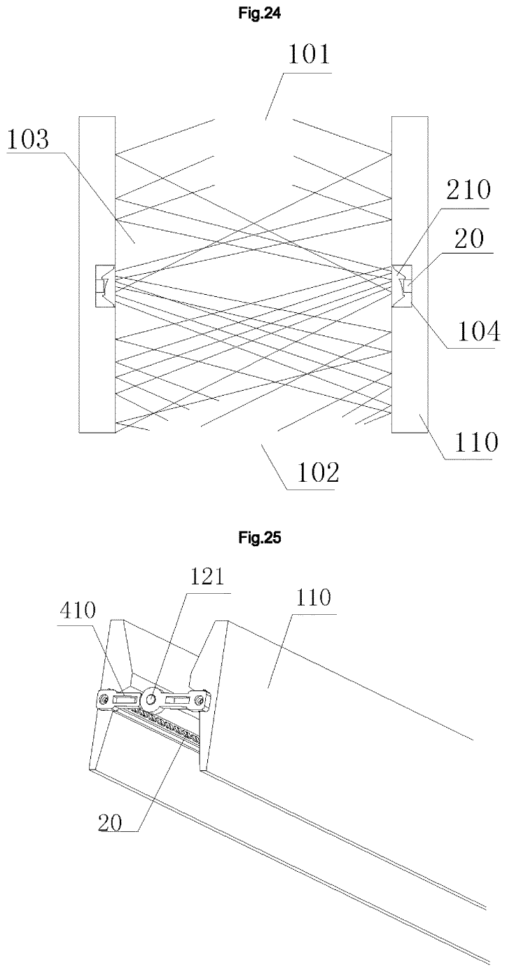

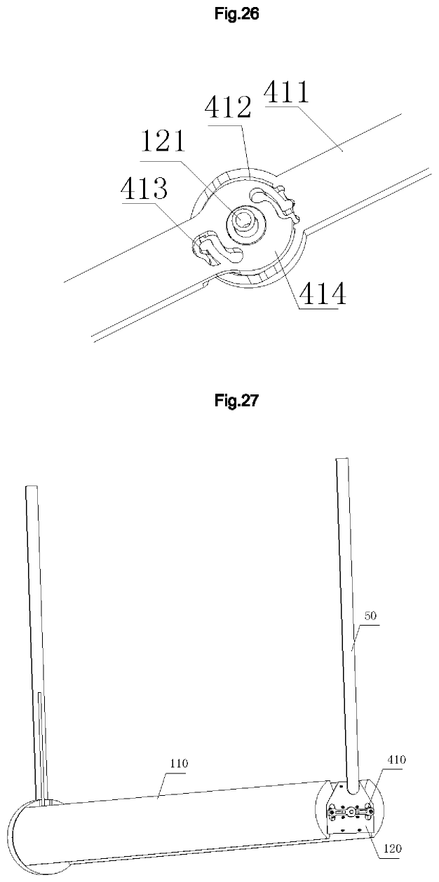

Different from Embodiment 1, in the present embodiment, as shown in FIGS. 25 and 26, two rotating portions 410 arranged in a pair sleeve one fixing shaft 121. A connecting end of one of the rotating portions 410 connected to the fixing shaft 121 is provided with a groove structure 412, and a connecting end of the other rotating portion 410 connected to the fixing shaft 121 is provided with a convex ring structure 414. The convex ring structure 414 is concentric with the groove structure 412, at least part of the convex ring structure 414 is accommodated in the groove structure 412, and the groove structure 412 is drivingly connected to the convex ring structure 414 by means of a rotating structure 413.

Specifically, the convex ring structure 414 is drivingly connected to the groove structure 412 by means of the rotating structure 413, such that the effect of linkage between the two reflecting plates 110 is achieved.

In an embodiment mode, the rotating structures 413 are pawl structures. The pawl structure includes ratchet grooves circumferentially arranged along an inner wall surface of the groove structure 412, and ratchet teeth arranged on an outer circumferential surface of the convex ring structure 414.

It should be noted that the pawl structure is not limited to the above structural arrangement. The pawl structure may also include ratchet teeth circumferentially arranged along an inner wall surface of the groove structure 412, and ratchet grooves arranged on an outer circumferential surface of the convex ring structure 414.

In the present embodiment, rotating fit achieved by the ratchet teeth and the ratchet groove has a desirable positioning effect. When the reflecting plate 110 is not subjected to an external force, the first ratchet tooth is accommodated in the first ratchet groove to limit the reflecting plate 110. After the reflecting plate 110 is subjected to an external force, the first ratchet tooth moves from the first ratchet groove to the second ratchet groove, to link the two reflecting plates 110. When the first ratchet tooth moves into the second ratchet groove, the two reflecting plates 110 are limited.

### Embodiment 5

Different from Embodiment 1, in the present embodiment, as shown in FIG. 27, surfaces of the two reflecting plates 110 arranged in a pair, which are away from each other, are curved surfaces.

Specifically, surfaces of the two reflecting plates 110 arranged in a pair, which are away from each other, are planes, such that attractive requirements of different people on the lamp body 10 is satisfied.

It should be noted that curvature of the curved surfaces are adaptively set as needed.

### Embodiment 6

Different from Embodiment 1, in the present embodiment, a linkage structure between the two reflecting plates 110 is achieved by cooperation of the link rod assembly 60 and the positioning connector 70, instead of the rotating portions 410, so as to adjust the top light output port 101 and the bottom light output port 102 between the two reflecting plates 110.

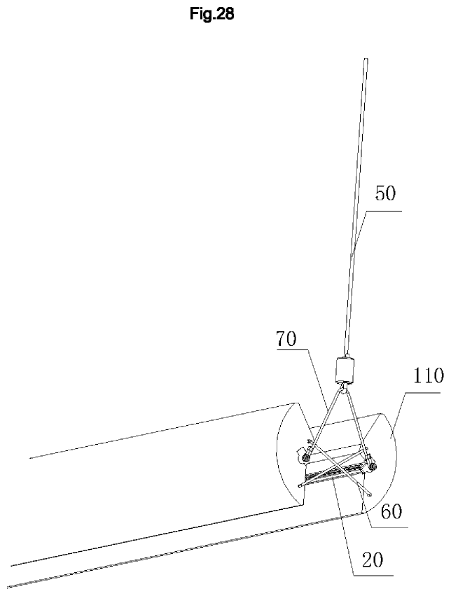

As shown in FIG. 28, the lamp includes the link rod assembly 60 and the positioning connector 70. The two reflecting plates 110 arranged in a pair are in linked and cooperate by means of the link rod assembly 60, and the two reflecting plates 110 are connected to the mounting member 50 by means of the positioning connector 70.

The positioning connector 70 is a flexible connector made from flexible materials such as a chain or a lanyard, and the positioning connector 70 may also be a connector with strength such as a connecting rod.

When the positioning connector 70 is flexible connectors, the mounting member 50 is provided with a hanging ring, one end of the positioning connector 70 is connected to one of the two reflecting plates 110 arranged in a pair, and the other end of the positioning connector 70 penetrates the hanging ring and then is connected to one of the two reflecting plates 110.

Specifically, the two reflecting plates 110 are connected to two ends of the positioning connector 70 respectively. The positioning connector 70 is hung on the hanging ring, such that the positioning connector 70 is deformed and changed adaptively when the two reflecting plates 110 rotate.

When the positioning connector 70 is a connecting rod, one ends of the positioning connector 70 is connected to the reflecting plate 110, and the other end of the positioning connector 70 is connected to the mounting member 50.

In the present embodiment, a connection position of the positioning connector 70 and the reflecting plate 110 is located in the middle area of the reflecting plate 110 in the height direction.

In an embodiment mode, the link rod assembly 60 includes two link rods symmetrically arranged to define an angle therebetween, two ends of each link rod are connected to the two reflecting plates 110 respectively, a distance between a first end of each link rod and the top light output port 101 is less than a distance between a second end of each link rod and the top light output port 101, and the two link rods form an X-shaped structure.

The two link rods intersect to form an X-shaped structure. It should be noted that there is no fixed intersection point between the two link rods, that is, the two link rods make no contact. A gap is formed between the two link rods in a length range of the reflecting plates 110, such that a phenomenon that the reflecting plates 110 may not rotate due to abutting of the link rods does not occur when the reflecting plate 110 are adjusted.

In the present embodiment, since the length of the link rods is fixed, the link rods have a limiting effect. In a process of rotating the reflecting plates 110, the two reflecting plates 110 may generate linkage rotation, and relative movement between the two reflecting plates 110 does not occur.

In the present embodiment, ends of the link rods have bending portions. The reflecting plates 110 have mounting holes. At least part of each bending portion passes through the mounting hole, and the bending portion cooperates with the mounting hole rotatably. Connection between the link rods and the reflecting plates 110 is implemented by hooking the bending portions of the link rods at the mounting holes. Since the connection is performed by means of the bending portions and the mounting holes, the link rods may cooperate with the reflecting plates 110 rotatably, such that the reflecting plates 110 are rotated. A friction force also exists between the link rods and the reflecting plates 110, such that damping is realized between the link rods and the reflecting plates 110. The reflecting plates 110 have a positioning effect when the link rods and the reflecting plates 110 are not subjected to an external force.

### Embodiment 7

Different from Embodiment 1, in the present embodiment, the reflecting plates 110 are removably connected to the end plates 120, that is, the luminous flux of the top light output port 101 and the bottom light output port 102 is adjusted by moving the reflecting plates 110.

In an embodiment mode, the end plates 120 are provided with slide grooves, the reflecting plates 110 are provided with protruding structures at least partially extending into the slide grooves, and the protruding structures are removable in the slide grooves.

In a particular embodiment, the slide grooves extend in a direction in which the two reflecting plates 110 face each other, such that the two reflecting plates 110 get move close to or away from each other by means of the slide grooves.

Specifically, the luminous flux of the top light output port 101 and the luminous flux of the bottom light output port 102 are reduced by moving the two reflecting plates 110 close to each other. The top light output port 101 and the bottom light output port 102 are increased by moving the two reflecting plates 110 away from each other.

In another particular embodiment, the slide grooves extend in a direction of the top light output port 101 and the bottom light output port 102, such that the two reflecting plates 110 are flush or misaligned in the direction of the top light output port 101 and the bottom light output port 102.

Specifically, by moving the reflecting plates 110 in the direction of the top light output port 101 and the bottom light output port 102, a reflecting area is changed, such that the luminous flux of the top light output port 101 and the bottom light output port 102 is changed.

In another particular embodiment, the slide grooves extend in a direction defining an angle with a direction in which the two reflecting plates 110 face each other, such that the two reflecting plates 110 are aligned or misaligned.

Specifically, by moving the reflecting plates 110 in a direction defining an angle with the direction in which the two reflecting plates 110 face each other, the two reflecting plates 110 are moved away from each other and misaligned simultaneously. The two reflecting plates 110 are moved away from each other and the two reflecting plates 110 are misaligned simultaneously, so as to adjust the luminous flux of the top light output port 101 and the bottom light output port 102.

### Embodiment 8

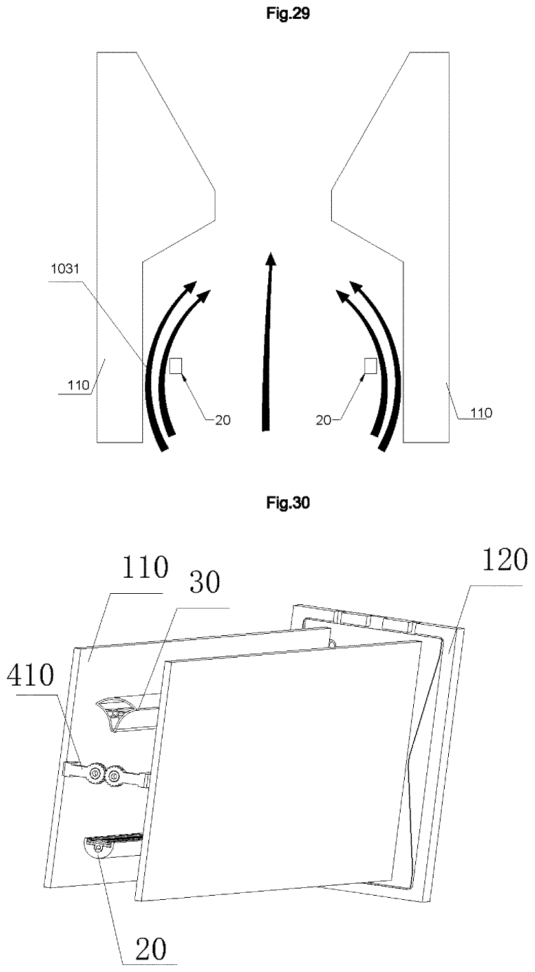

Different from Embodiment 1, in the present embodiment, as shown in FIGS. 29 and 30, the light source 20 is arranged in the light reflecting channel 103 defined between the two reflecting plates 110.

Specifically, the light source 20 is arranged on an end cover. The light source 20 is not connected to the two reflecting plates 110, and heat dissipation gaps 1031 are formed between the light source 20 and the two reflecting plates 110.

In an embodiment mode, one or more light sources 20 are provided. When one light source 20 is provided, distances between the light source 20 and the reflecting surfaces of the two reflecting plates 110 are equal. When a plurality of light source 20 are provided, the plurality of light source 20 form a light source 20 mounting area, and distances between the light source 20 mounting area and the two reflecting plates 110 are equal. For example, when two light sources 20 are provided, one of the two reflecting plates 110 oppositely arranged is the first reflecting plate 110, the other of the two reflecting plates 110 oppositely arranged is the second reflecting plate 110, and a distance between the first light source 20 closer to the first reflecting plate 110 and the first reflecting plate 110 is equal to a distance between the second light source 20 closer to the second reflecting plate 110 and the second reflecting plate 110.

### Embodiment 9

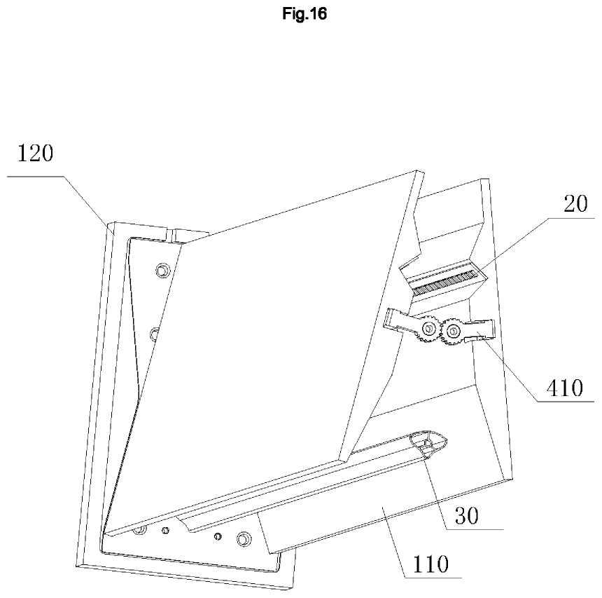

Different from Embodiment 1, in the present embodiment, as shown in FIGS. 1 and 16, the lamp further includes a light blocking bar 30.

Specifically, the light blocking bar 30 is arranged in the light reflecting channel 103. A light output end of the light source 20 is arranged towards the light blocking bar 30. At least a surface of the light blocking bar 30 facing the light source 20 is a reflecting surface, and a technical effect of reflecting light is achieved by the reflecting surface of the light blocking bar 30, such that the luminous flux of the top light output port 101 and the bottom light output port 102 is adjusted.

In an embodiment mode, in the direction of the top light output port 101 and the bottom light output port 102, the light blocking bar 30 is located between the light source 20 and the top light output port 101, and the light blocking bar 30 may also be located between the light source 20 and the bottom light output port 102.

The light blocking bar 30 is arranged on the end plates 120, such that the light blocking bar 30 is positioned.

In an embodiment mode, an outer surface of the light blocking bar 30 is formed by a plurality of light reflecting surfaces connected in sequence, and the light reflecting surfaces facing the light source 20 are configured to guide light to the top light output port 101 and/or the bottom light output port 102.

In an embodiment mode, at least one end surface of the plurality of light reflecting surfaces is a plane.

In an embodiment mode, at least one end surface of the plurality of light reflecting surfaces is an arc-shaped surface. When the plurality of light reflecting surfaces are all arc-shaped surfaces, the outer surface of the light blocking bar 30 includes a first arc-shaped section 301, a second arc-shaped section 302 and a third arc-shaped section 303 connected in sequence end to end. Two of the first arc-shaped section 301, the second arc-shaped section 302 and the third arc-shaped section 303 are concave arcs, and the other one is a convex arc.

In the present embodiment, the two concave arcs are symmetrically arranged with respect to the convex arc, such that the outer surface of the light blocking bar 30 is of a symmetrical structure for reflecting light. Curvature radii of the two concave arcs may also be different, such that the outer surface of the light blocking bar 30 is a light reflecting surface with an asymmetric structure for light reflection.

In the direction of the top light output port 101 and the bottom light output port 102, the light blocking bar 30 is located between the light source 20 and the top light output port 101, and when the convex arc faces the light source 20, the light blocking bar 30 is in a first state. In the direction of the top light output port 101 and the bottom light output port 102, the light blocking bar 30 is located between the light source 20 and the top light output port 101, and when the concave arcs face the light source 20, the light blocking bar 30 is in a second state.

In the direction of the top light output port 101 and the bottom light output port 102, the light blocking bar 30 is located between the light source 20 and the bottom light output port 102, and when the convex arc faces the light source 20, the light blocking bar 30 is in a third state. In the direction of the top light output port 101 and the bottom light output port 102, the light blocking bar 30 is located between the light source 20 and the bottom light output port 102, and when the concave arcs face the light source 20, the light blocking bar 30 is in a fourth state.

In the present embodiment, the light blocking bar 30 is movably arranged in the light reflecting channel 103. The light blocking bar 30 is movably mounted on the end plates 120 of the lamp, such that a position of the light blocking bar 30 is adjusted. The light blocking bar 30 may switch a light blocking surface by rotating, and the light blocking bar 30 may also adjust a distance between the light blocking bar 30 and the light source 20 by removable up and down.

### Embodiment 10

Different from Embodiment 1, in the present embodiment, the fixing structures are hole structures provided in the end plates 120.

Specifically, the rotating portion 410 includes an extension arm 411 and a rotating head arranged at an end of the extension arm 411. A convex column is arranged on the rotating head, at least part of the convex column may extend into the hole structure, and the convex column is in rotating fit with the hole structure.

### Embodiment 11

Different from Embodiment 1, in the present embodiment, the rotating mechanisms are located at one sides of the end plates 120 facing the light reflecting channel 103. The fixing structures are fixing shafts 121.

Specifically, the fixing shafts 121 are located on inner side surfaces of the end plates 120 facing the light reflecting channel 103 and extend in a direction facing the light reflecting channel 103, and at least parts of the rotating mechanisms rotatably sleeve the fixing shafts 121.

In the present embodiment, the rotating mechanisms include rotating portions 410. One ends of the rotating portions 410 are fixedly connected to the reflecting plates 110, the other ends of the rotating portions 410 rotatably sleeve the fixing shafts 121, and two rotating portions 410 located on the same side of the reflecting plate 110 are rotatably connected.

### Embodiment 12

Different from Embodiment 1, in the present embodiment, the rotating mechanisms are located at one sides of the end plates 120 facing the light reflecting channel 103. The fixing structures are hole structures provided on the end plates 120.

Specifically, the rotating mechanisms include rotating portions 410. Each rotating portion 410 includes an extension arm 411 and a rotating head arranged at an end of the extension arm 411. A convex column is arranged on the rotating head, at least part of the convex column may extend into the hole structure, and the convex column is in rotating fit with the hole structure.

### Embodiment 13

Different from Embodiment 1, in the present embodiment, no end plate 120 is required. The two reflecting plates 110 oppositely arranged are arranged on the rotating shaft. The two reflecting plates 110 are both rotatably connected to the rotating shaft.

Specifically, the lamp includes a rotating shaft and a mounting member. The two reflecting plates oppositely arranged are both rotatably connected to the rotating shaft. The mounting member 50 is rotatably connected to the rotating shaft, and the mounting member 50 is configured to be mounted at a mounting position.

The mounting member is of a rod structure. The rod structure sleeves the rotating shaft and is in rotating fit with the rotating shaft. Moreover, the rod structure provides mounting for the rotating shaft, so as to position the rotating shaft.

In an embodiment mode, the lamp further includes connecting arms, where each reflecting plate 110 is rotatably connected to the rotating shaft by means of the connecting arm, one ends of the connecting arms are fixedly connected to the reflecting plates, and the other ends of the connecting arms rotatably sleeve the rotating shaft.

In the present embodiment, the reflecting plates 110 are connected to the rotating shaft by means of the connecting arms, such that the reflecting plates 110 are positioned. Since the reflecting plates 110 are both rotatably connected to the rotating shaft, the two reflecting plates 110 arranged in linkage may automatically correct positions under the gravity of the reflecting plates 110.

It should be noted that the rotation connection between the connecting arm and the rotating shaft and between the rod structure and the rotating shaft may be implemented by means of bearings.

Certainly, apart from use of a rod structure, use of a flexible rope may also implement connection.

In the present embodiment, two ends of the rotating shaft in an axial direction are provided with stop protruding structures in order to avoid a phenomenon that the connecting arm falls off.

### Embodiment 14

Different from Embodiment 1, in the present embodiment, no end plate 120 is required. The two reflecting plates 110 oppositely arranged are arranged on the rotating shaft. One reflecting plate 110 is rotatably connected to the rotating shaft, and the other reflecting plate 110 is fixedly connected to the rotating shaft.

Specifically, the lamp includes the rotation shaft and a mounting member. The mounting member 50 is rotatably connected to the rotating shaft, and the mounting member 50 is configured to be mounted at a mounting position.

The mounting member is of a rod structure. The rod structure sleeves the rotating shaft and is in rotating fit with the rotating shaft. Moreover, the rod structure provides mounting for the rotating shaft, so as to position the rotating shaft.

In an embodiment mode, the lamp further includes a connecting arm and a fixing arm. One end of the connecting arm is fixedly connected to one of the reflecting plates, and the other end of the connecting arm rotatably sleeves the rotating shaft. One end of the fixing arm is fixedly connected to one of the reflecting plates, and the other end of the fixing arm is fixedly connected to the rotating shaft. The rotating shaft rotates synchronously with the corresponding reflecting plate 110 by means of the fixing arm.

In the present embodiment, the rotating shaft is configured to provide positioning for the reflecting plates 110. Since the rotating shaft is rotatably connected to the mounting member, the two reflecting plates are linked, and the positions of the two reflecting plates 110 are automatically corrected under the action of gravity.

It should be noted that the rotation connection between the connecting arm and the rotating shaft and between the rod structure and the rotating shaft are implemented by means of bearings.

Certainly, apart from use of a rod structure, use of a flexible rope may also implement connection.

In the present embodiment, two ends of the rotating shaft in an axial direction are provided with stop protruding structures in order to avoid a phenomenon that the connecting arm falls off.

From the above description, it may be seen that the above embodiments of the disclosure achieve the following technical effects:

The lamp in the disclosure uses a structure of double light output ports of a top light output port 101 and a bottom light output port 102. Moreover, the disclosure has the reflecting plate 110 arranged movably, such that movable adjustment is performed by means of the reflecting plate 110, then light is reflected towards the top light output port 101 or the bottom light output port 102, and a function of guiding light is achieved. The luminous flux of the top light output port 101 and the bottom light output port 102 is adjusted by adjusting the reflecting plates 110, such that the output light is adjusted according to requirements of a use scene, and the user experience is improved.

Apparently, the embodiments described are merely some embodiments rather than all embodiments of the disclosure. Based on the embodiments of the disclosure, all other embodiments obtained by those of ordinary skill in the art without making creative efforts should fall within the scope of protection of the disclosure.

It should be noted that the terms used herein are for the purpose of describing detailed embodiments merely and are not intended to be limiting of the illustrative embodiments in accordance with the disclosure. As used herein, the singular is intended to include the plural unless the context clearly dictates, and furthermore, it is to be understood that the terms “include” and/or “comprise”, when used in this specification, specify the presence of features, steps, works, devices, components, and/or combinations thereof.

It should be noted that the terms “first”, “second” and so forth, in the specification and claims of the disclosure and in the above-mentioned drawings, are used to distinguish between similar objects and not necessarily to describe a particular order or sequential order. It should be understood that the data used in this way may be interchanged where appropriate, such that the embodiments of the disclosure described herein may be implemented in other sequences than those illustrated or described herein.

What are described above are merely preferred embodiments of the disclosure and not intended to limit the disclosure, and various changes and modifications may be made to the disclosure by those skilled in the art. Any modifications, equivalent substitutions, improvements, etc. within the spirit and principles of the disclosure are intended to fall within the scope of protection of the disclosure.

What is claimed is:

1. A lamp, comprising:
a lamp body, wherein the lamp body comprises two reflecting plates arranged oppositely, a light reflecting channel is defined between the two reflecting plates, the light reflecting channel is provided with a top light output port and a bottom light output port, and at least one reflecting plate of the two reflecting plates is arranged movably; and
a light source, wherein the light source is arranged in the light reflecting channel, the reflecting plates are configured to guide light irradiating the reflecting plates to the top light output port and the bottom light output port and the reflecting plate arranged movably increases or decreases a luminous flux of the top light output port and the bottom light output port.

2. The lamp according to claim 1, wherein
a light output direction of the light source and an opening direction of the bottom light output port are arranged to define an included angle, such that the light source does not directly irradiate the bottom light output port; and/or
surfaces of the two reflecting plates facing each other are reflecting surfaces, and the reflecting surfaces are configured to reflect light in the light reflecting channel, so as to guide the light to the top light output port and/or the bottom light output port

3. (canceled)

4. The lamp according to claim 1, wherein
the light source is arranged in an area between the two reflecting plates; or
the light source is mounted on one of the reflecting plates and the light source emits light towards the other reflecting plate of the reflecting plates or,
the light source is mounted on each reflecting plate of the reflecting plates, and the light source on each reflecting plate emits light towards the reflecting plate on the opposite side.

5. The lamp according to claim 1, wherein at least part of the light source is supported on the reflecting plates and defines heat dissipation with the reflecting plates.

6. The lamp according to claim 1, wherein surfaces of the two reflecting plates facing each other are reflecting surfaces, the light source is mounted on the reflecting surfaces, and
the light source is directly connected to the reflecting surfaces; and/or
the reflecting surfaces are provided with mounting grooves in communication with the light reflecting channel and at least part of the light source is mounted in the mounting grooves and emits light towards the light reflecting channel

7. The lamp according to claim 1, further comprising a polarizing lens, wherein the polarizing lens covers the light source, and at least part of light of the light source passes through the polarizing lens and then is emitted towards the light reflecting channel.

8. The lamp according to claim 1, wherein surfaces of the two reflecting plates facing each other are reflecting surfaces, the reflecting surface is provided with a first groove wall slope and a second groove wall slope that are arranged to define an angle therebetween, a joint of the first groove wall slope and the second groove wall slope is provided with a positioning groove that is opened in an extension direction of the first groove wall slope or the second groove wall slope, at least part of the light source is accommodated in the positioning groove, and at least the other part of the light source arranged on the first groove wall slope or the second groove wall slope.

9. The lamp according to claim 1, wherein surfaces of the two reflecting plates facing each other are reflecting surfaces, the reflecting surfaces comprise a plurality of sub-planes, and
the plurality of sub-planes are coplanar; or,
at least two of the plurality of sub-planes are arranged to define an angle therebetween.

10. The lamp according to claim 1, wherein a reflecting surface of the reflecting plate at least has a flat surface, a first groove wall slope, a second groove wall slope and a second slope that are connected in sequence in a direction of the top light output port and the bottom light output port, the light source is mounted on the first groove wall slope and/or the second groove wall slope, and the light source emits light towards the light reflecting channel.

11. The lamp according to claim 1, further comprising:
end plates, wherein the end plates are arranged on two sides of the reflecting plates in pairs, the end plates and the reflecting plates define the light reflecting channel, the top light output port and the bottom light output port, and the reflecting plates are rotatably and/or removably connected to the end plates; and
mounting members, wherein the mounting members are connected to the end plates and/or the reflecting plates and the mounting members are configured to be mounted at mounting positions.

12. The lamp according to claim 11, wherein when the reflecting plates are rotatably connected to the end plates, the lamp further comprises rotating mechanisms, and the reflecting plates are rotatably connected to the end plates by means of the rotating mechanisms.

13. The lamp according to claim 12, wherein
the rotating mechanisms are located on one sides of the end plates facing the light reflecting channel; or,
the rotating mechanisms are located on different sides of the end plates and comprise mounting protrusions, one ends of the mounting protrusions are fixedly connected to the reflecting plates, and the other ends of the mounting protrusions penetrate the end plates.

14. The lamp according to claim 13, wherein the end plate is provided with arc-shaped grooves arranged in a pair, and axial ends of the mounting protrusions of the rotating mechanisms pass through the arc-shaped grooves.

15. The lamp according to claim 12, wherein the rotating mechanisms further comprise rotating portions, one ends of the rotating portions are rotatably connected to the end plates, and the two rotating portions located on the same side of the end plate are drivingly connected to link the two reflecting plates.

16. The lamp according to claim 15, wherein
the other ends of the rotating portions are connected to the reflecting plates; or
the rotating mechanisms further comprise mounting protrusions, one ends of the mounting protrusions are connected to the reflecting plates, the other ends of the mounting protrusions penetrate the end plates so as to be connected to the other ends of the rotating portions located on outer sides of the end plates, and the rotating portions and the mounting protrusions are connected to define an angle therebetween; or,
the rotating portions comprise extension arms and rotating heads arranged at one ends of the extension arms, and the rotating heads of the two rotating portions drivingly connected are rotatably connected.

17. The lamp according to claim 12,
further comprising fixing structures, wherein the fixing structures are arranged on the end plates, one ends of the rotating mechanisms are rotatably connected to the fixing structures, and the fixing structures are located in middle areas of the end plates; or,
the top light output port and the bottom light output port are located at two ends of the reflecting plates in a direction of the top light output port and the bottom light output port, and mounting protrusions of the rotating mechanisms are located in middle areas of the reflecting plates in the direction of the top light output port and the bottom light output port.

18. The lamp according to claim 17, wherein
the fixing structures are fixing shafts, the fixing shafts are located on inner side surfaces of the end plates facing the light reflecting channel and extend in a direction facing the light reflecting channel, and at least parts of the rotating mechanisms rotatably sleeve the fixing shafts or
the fixing structures are fixing shafts, the fixing shafts are located on outer side surfaces of the end plates away from the light reflecting channel and extend in a direction away from the light reflecting channel, and at least parts of the rotating mechanisms rotatably sleeve the fixing shafts; or,
the fixing structures are hole structures arranged on the end plates, and at least parts of the rotating mechanisms extend into the hole structures and are rotatably connected to the hole structures.

19. The lamp according to claim 18, wherein the fixing structures are fixing shafts, and two rotating mechanisms arranged in a pair sleeve one fixing shaft, wherein a connecting end of one of the rotating mechanisms connected to the fixing shaft is provided with a groove structure, a connecting end of the other rotating mechanism connected to the fixing shaft is provided with a convex ring structure, the convex ring structure is concentric with the groove structure, at least part of the convex ring structure is accommodated in the groove structure, and the groove structure is drivingly connected to the convex ring structure by means of a rotating structure.

20. The lamp according to claim 19, wherein the rotating structures are pawl structures, and
the pawl structure comprises ratchet grooves circumferentially arranged along an inner wall surface of the groove structure, and ratchet teeth arranged on an outer circumferential surface of the convex ring structure; or,
the pawl structure comprises ratchet teeth circumferentially arranged along an inner wall surface of the groove structure, and ratchet grooves arranged on an outer circumferential surface of the convex ring structure.

21. The lamp according to claim 18, wherein the fixing structures are fixing shafts, two rotating mechanisms arranged in a pair sleeve two fixing shafts respectively, and
one ends of the two rotating mechanisms connected to the fixing shafts are connecting ends, and the two connecting ends mesh; and/or
the lamp further comprises a drive member, one ends of the two rotating mechanisms connected to the fixing shafts are connecting ends, and the drive member is drivingly connected to the connecting ends.

22. The lamp according to claim 1, further comprising:
a rotating shaft, wherein at least one of the two reflecting plates oppositely arranged is rotatably connected to the rotating shaft; and
a mounting member, wherein the mounting member is rotatably connected to the rotating shaft, and the mounting member is configured to be mounted at a mounting position.

23. The lamp according to claim 22, further comprising connecting arms, wherein each reflecting plate is rotatably connected to the rotating shaft by means of the connecting arm, one ends of the connecting arms are fixedly connected to the reflecting plates, and the other ends of the connecting arms rotatably sleeve the rotating shaft.

24. The lamp according to claim 22, further comprising:
a connecting arm, wherein one end of the connecting arm is fixedly connected to one of the reflecting plates, and the other end of the connecting arm rotatably sleeves the rotating shaft; and
a fixing arm, wherein one end of the fixing arm is fixedly connected to one of the reflecting plates, and the other end of the fixing arm is fixedly connected to the rotating shaft.

25. The lamp according to claim 1, comprising:
a link rod assembly, wherein the two reflecting plates arranged in a pair are linked and cooperate by means of the link rod assembly;
a mounting member, wherein the mounting member is connected to the reflecting plates, and the mounting member is configured to be mounted at a mounting position; and
positioning connectors, wherein the reflecting plates are connected to the mounting member by means of the positioning connectors.

26. The lamp according to claim 25, wherein
the positioning connectors are flexible connectors, the mounting member is provided with a hanging ring, one end of the positioning connector is connected to one of the two reflecting plates arranged in a pair, and the other end of the positioning connector penetrates the hanging ring and then is connected to one of the two reflecting plates; or,
the positioning connectors are connecting rods, one ends of the positioning connectors are connected to the reflecting plates, and the other ends of the positioning connectors are connected to the mounting member.

27. The lamp according to claim 25, wherein the link rod assembly comprises two link rods symmetrically arranged to define an angle therebetween, two ends of each link rod are connected to the two reflecting plates respectively, a distance between a first end of each link rod and the top light output port is less than a distance between a second end of each link rod and the top light output port, and the two link rods form an X-shaped structure.

28. The lamp according to claim 12, wherein when the reflecting plates are removably connected to the end plates, the end plates are provided with slide grooves, the reflecting plates are provided with protruding structures at least partially extending into the slide grooves, the protruding structures are removable in the slide grooves, and
the slide grooves extend in a direction in which the two reflecting plates face each other, such that the two reflecting plates move close to or away from each other; and/or,
the slide grooves extend in a direction of the top light output port and the bottom light output port, such that the two reflecting plates are flush or misaligned in the direction of the top light output port and the bottom light output port; and/or,
the slide grooves extend in a direction defining an angle with a direction in which the two reflecting plates face each other, such that the two reflecting plates are aligned or misaligned.

29. The lamp according to claim 12, further comprising light leakage preventing members, wherein the light leakage preventing members are arranged between the reflecting plates and the end plates, and the light leakage preventing members are made from one or a combination of at least two of felt, original cork, environment-friendly recycled plastic fabric, recycled wood, bamboo and wood fiber boards.

30. The lamp according to claim 1, further comprising a light blocking bar, wherein the light blocking bar is arranged in the light reflecting channel, a light output end of the light source is arranged towards the light blocking bar, at least a surface of the light blocking bar facing the light source is a reflecting surface, and
the light blocking bar is located between the light source and the top light output port in the direction of the top light output port and the bottom light output port; or,
the light blocking bar is located between the light source and the bottom light output port in the direction of the top light output port and the bottom light output port.

31. The lamp according to claim 30, wherein the light blocking bar is movably arranged in the light reflecting channel.

32. The lamp according to claim 1, wherein the reflecting plates are arranged in pairs, and
surfaces of the two reflecting plates arranged in a pair, which are away from each other, are planes or curved surfaces; and/or,
the reflecting plates are made from a translucent material or a transparent material; and/or,
surfaces of the two reflecting plates arranged in a pair, which are close to each other, are covered with light reflecting films, light reflecting paint, or light reflecting powder.

33. The lamp according to claims 1-29, wherein
the light source is movably arranged in the light reflecting channel; and/or,
the light source is a linear light source; and/or,
the light source is mounted on end plates of the lamp; and/or,
the light blocking bar of the lamp is arranged on the end plates of the lamp; and/or,
the lamp is a strip lamp.
